(19) United States
(12) Patent Application Publication
(10) Pub. No.: US 2013/0071800 A1
(43) Pub. Date: Mar. 21, 2013

(54) METHOD FOR FIRING RAW CERAMIC BLANKS AND FURNACE

(71) Applicants: HEINER GAUSMANN, HASBERGEN (DE); PETER HEITMANN, HORSTMAR (DE); RAINER HÜSING, SPELLE (DE)

(72) Inventors: HEINER GAUSMANN, HASBERGEN (DE); PETER HEITMANN, HORSTMAR (DE); RAINER HÜSING, SPELLE (DE)

(73) Assignee: Keller HCW GmbH, Ibbenboreb-Laggenbeck (DE)

(21) Appl. No.: 13/612,065

(22) Filed: Sep. 12, 2012

(30) Foreign Application Priority Data
Sep. 12, 2011 (DE) 10 2011 112 838.0

(51) Int. Cl. F27B 9/02; F27D 15/00; F27B 9/10

(52) U.S. Cl. CPC F27B 9/022; F27B 9/10; F27D 15/00
USPC 432/11; 432/26; 432/121; 432/152; 432/201; 432/239

(57) ABSTRACT

A method for firing raw ceramic blanks in a furnace includes the steps of guiding trains of blanks running parallel to one another along a longitudinal furnace section having a firing zone, wherein the trains are moved in opposite directions during one movement operation, and the furnace is loaded using blanks to be moved in a first direction. A furnace for firing raw ceramic blanks having a plurality of trains which are arranged parallel to one another and can move along a longitudinal furnace section, so trains comprising a plurality of furnace bogies on which the blanks are to be arranged, wherein the furnace section has a firing zone, and wherein the trains are moved in opposite directions, and the furnace is at a first end of the furnace section for loading the blanks to be moved in a first direction into the furnace.

### CROSS REFERENCE

This application claims priority to German Patent Application No. 10 2011 112 838.0, filed Sep. 12, 2011.

### BACKGROUND OF THE INVENTION

DE 44 42 850 A1 describes related art. A generic furnace would be expensive to design and would be susceptible to trouble due to the technology used for implementation of the blanks in the firing zone with the goal of reversing the direction. The same thing is also true of the cooling air supply that is used.

### SUMMARY OF THE INVENTION

The object of the present invention is to design a method and/or a furnace of the type identified previously, so that it will be less susceptible to trouble and will be energy saving on the whole.

The object defined above is achieved by a method according to the invention as defined in claim 1 and by an object according to the invention as defined in claim 11.

The method according to the invention is characterized in that the blanks to be moved in the opposite second direction B are loaded at a second end of the furnace section, which is opposite the first end with respect to the firing zone, the blanks are each moved through the firing zone on their respective furnace trains without a reversal in direction and they are unloaded from the furnace section at the end of the same, which is opposite the loading point. Due to the blanks moving past one another on both ends of the firing zone and/or waiting side by side during the standing times, the energy released by the blanks already leaving the firing zone is used for heating the blanks that have not yet entered the firing zone. There is no reversal of direction in the firing zones, so that these blanks need only pass through the firing zone. The structural complexity in the area of the firing zone is reduced accordingly. This device is less susceptible to trouble. Although the furnace section is designed to be linear in particular and a crosswise offset in the firing zone is omitted, the blanks can also be brought together slightly or guided apart in a narrower or wider firing zone, depending on the desired furnace bogie guidance.

Due to the lack of a reversal in direction and/or a turnover in the firing zone, the available space is utilized optimally. The turnover of the furnace bogies outside of the firing zone can take place more rapidly in the long run than within the firing zone in the prior art identified above, which in turn saves even more energy. The furnace according to the invention therefore also has a higher throughput than the furnace known from the prior art. A complex and susceptible turnover technology may be omitted in the high temperature range of the furnace.

The blanks in the firing zone are preferably heated by at least one heating and/or firing element arranged in a longitudinal channel between the trains. In this way, the heating energy that is used can be applied more directly to the blanks, which leads to an increased efficiency in the firing zone and also to a reduced energy consumption. The heating of the bricks or similar blanks may occur directly and uniformly over their structural height but distributed throughout the stock.

In another embodiment of the method according to the invention, the blanks are heated in the firing zone by at least one heating element arranged above the longitudinal channels. Such a design is advantageous in particular with a directed release of heating energy into the longitudinal channels between the furnace trains when there is not enough available space for heating elements in the longitudinal channels. In this case, the heating elements are then preferably arranged directly above the longitudinal channels.

The blanks of a train which are still upstream from the firing zone are preferably heated by the radiant heat of the blanks of the neighboring furnace train moving in the opposite direction in coming out of the firing zone; this occurs in radiant heat zones which are several furnace bogies long in particular and are connected along the furnace section on both ends of the firing zone. The same thing is also true of a furnace train, which is limited at both ends by furnace trains that can move in the opposite direction. Furnace bogies here are understood to refer to any type of conveyance means for raw blanks. For example, it may be a carriage or a carrier for raw blanks.

The raw blanks (not yet fired) are advantageously heated in the absence of cooling air (heated), which is passed along the furnace section and through the firing zone. This leads to great energy savings because heat losses due to cooling air that is carried away are prevented. Cooling air here is understood to refer to air that is injected to cool blanks that have already been fired in known furnaces, to absorb their heat and to release this heat downstream from the firing zone to raw blanks that have not yet been fired. Cooling air does not include secondary air, which is supplied for the purpose of enrichment of the oxygen content in the flue gas/air mixture, e.g., to produce a certain brick color. The blanks that have already been fired are also cooled in the absence of cooling air but with the heat released to the dry blanks.

There is thus no targeted guidance of the cooling air through the firing zone, and the heat that can be transported from the air/flue gas mixture in the radiant heat zone is negligible. In comparison with tunnel furnaces that operate with cooling air, the energy savings amount to as much as 40%. Due to the absence of cooling air systems, the furnace can also be manufactured less expensively and does not require as much maintenance.

The use of circulation zones on both ends of the firing zone is also particularly advantageous; in the circulation zone, air is circulated across the longitudinal direction of the furnace, achieving an equal temperature distribution among the blanks on the furnace bogie. The proportion of cross-circulated air is preferably much greater than that of air moving along the furnace section, wherein the air in the furnace is to be understood in the preceding and following discussions to refer to a flue gas or a flue gas/air mixture and/or a gas mixture. The latter gas mixture is composed of the flue gases optionally occurring in the combustion process, secondary air, if any, supplied for enrichment of oxygen to 10% to 15%, for example, as well as air optionally entering the furnace section through a lateral airlock. The ratio of cross-circulated gas mass flow to the gas mass flow directed along the furnace section is preferably >10, even more preferably >25 and especially preferably >50. Due to the great differences in the gas mass flow longitudinally and crosswise to the furnace section, it is clear that there is only a slight gas mass flow in the longitudinal direction of the furnace section. Accordingly only a small amount of heat is lost in suction removal of the flue gas/air mixture. An equal distribution of the temperature over the entire stock of all the furnace trains in parallel with one another with the blanks to be cooled and/or to be heated is the goal due to the great circulation of air in the circulation zones.

For cross-circulation, the gas mixture in the furnace is drawn in by at least one fan situated in particular above and/or at the side of the trains and is preferably guided in the crosswise direction above a wall or an intermediate ceiling of the furnace to be guided downward, as seen in the longitudinal direction of the furnace section at the side of the outer furnace trains, and to flow inward again toward the center of the furnace section through the blanks and/or through small gaps between the blanks. The natural convection tendency of the gas mixture is supported by using a fan situated above the blanks to obtain the most resistance-free flow and to minimize the labor required to do so. The fan is preferably designed as a radial fan and draws in air through a recess in an intermediate ceiling, above which the air is then guided to the end. In particular, the air is guided in a flow-optimized manner, for which purpose preferably rounded borders of the flow channel and extensive avoidance of breakaway edges or the like can take into account the contours that cause turbulence.

The alternative or supplementary arrangement of one or more fans at the ends of the furnace section, in particular with at least one on each end, can lead to especially high circulation rates with a low structural height of the furnace.

The firing curve is advantageously varied by varying the rate of the cross-circulated air in the circulation zone. In particular the firing curve, i.e., the temperature of the blanks along the furnace section, may be varied in a plurality of circulation channels arranged side by side in the circulation zone. In addition to varying the firing curve as a function of the thrust time and the gross firing temperature, the temperature of the blanks (already fired or unfired) in the circulation zone may be obtained as a function of the (crosswise) circulation rate(s) in multiple (crosswise) circulation channels. The circulation rate is preferably varied through control of the fans.

To support the shaping of organic material into blanks, oxygen may be supplied in particular in a temperature range of <700° C. along the furnace section. Ambient air is preferably used for this purpose. The proportion of air supplied is on the order of magnitude of the mass flow directed along the furnace section. The goal is to increase the oxygen content in the flue gas from 3% to 10% or 15%, for example. Oxygen may be supplied in the circulation zone, either alternatively or in addition to supplying oxygen in the combustion chamber.

The object defined in the beginning is also achieved by a furnace, which is designed in particular for performing a method according to the invention as described above or below and which is characterized in that loading of the blanks to be moved in the opposite direction, namely the second direction B, on a second end of the furnace section, which is opposite the first end with respect to the firing zone, is provided. In the furnace according to the invention, the blanks can be moved in both directions for the firing zone without having a reversal of directions, and can be unloaded at the end of the furnace section opposite its point of loading. An airlock through which the furnace bogies can travel to an a loading and unloading device, preferably having a transfer stage equipped with a number of track sections corresponding to the number of furnace trains may be provided for this purpose on both ends of the furnace section. Then the furnace bogies carrying fired and/or unfired blanks may be shifted onto the track sections of the transfer stage.

The furnace section has two radiant heat zones and in particular two circulation zones, preferably between the opposite ends with respect to the firing zone. In the radiant heat zone, there is a no cross-circulation of the air supported by fans or the like because the proportion of heat emitted via radiant heat from the fired blanks is much greater than the heat transport that can be achieved via circulation between the blanks to be cooled and those to be heated. At the same time, the proportion of cross-circulated air in the circulation zones is much greater, i.e., by at least one order of magnitude, than the proportion of air transported longitudinally in the direction of the furnace section because of the circulation means used, which is a fan in most cases. The term “air” used here is understood to refer to a corresponding mixture of flue gas, which may be combined in small portions with ambient air.

The furnace section of a furnace according to the invention has a main tunnel in which the furnace bogies can be moved in parallel furnace trains. Starting with a lateral end of the furnace section, there may be first be a circulation zone, then a radiant heat zone and a central firing zone, followed by another radiant heat zone and then another circulation zone on the other end following the firing zone. The furnace section ends after this circulation zone. The furnace trains typically run on rails through a water bath. Due to the plurality of blanks running side by side in opposite directions from one another through a shared firing zone and a shared tunnel, in the radiant heat zone, the blanks that have just come from the firing zone heat up the blanks that have not yet entered the firing zone. The blanks that have already been fired cool down. Due to the cross-circulation of the air in the tunnel in the circulation zone and the even temperature distribution, which is desired there, as seen in cross section, the blanks that have already been fired cool down further while the unfired blanks gradually heat up. Due to the absence of a reversal of direction in the firing zone, this device is technically much simpler to implement.

At the same time a cooling air feed may be omitted because the cooling of the blanks that have already been fired, said cooling taking place in the radiant heat zone and in the circulation zone due to the unfired blanks. There is no targeted cooling of the fired blanks due to additional supply of air. Any suction device or suction removal of flue gas can be designed to have smaller dimensions accordingly.

At least one fan is provided for cross-circulation of the gas that is present in the circulation zone. Such a fan may be installed either in a side wall of the main tunnel or in the ceiling. In particular, however, at least one of the circulation zones will have at least one separate wall by which the at least one circulation channel running mainly across the main tunnel is separated from a main tunnel of the furnace section. The fan may then be arranged in this wall with an inflow side toward the main tunnel. A wall and/or ceiling above the blanks and an arrangement of the fan above the blanks in this ceiling supports the transfer of circulation of air rising upward anyway, which is then transported along an outer wall of the furnace along the circulation channel toward the ends, optionally with slight cooling, and then can be introduced into the main tunnel again or through another channel section at the end, introducing it into the main tunnel directly at the end.

A plurality of circulation channels, which are separated from one another structurally, is preferably arranged in the longitudinal direction of the furnace section. To this extent, a plurality of cross-channels is formed above the main channel using an intermediate ceiling or external channels, e.g., in the form of pipes, preferably with at least one fan being assigned to each cross-channel. The use of an intermediate ceiling in particular permits systems that can be insulated well on the outside. By separate control of the fans, the temperature distribution in the zone can be controlled and the firing curve of the furnace can be designed to be variable.

In a furnace having a plurality of fans in the respective circulation zones, the arrangement of the fans is advantageously such that they are offset in relation to one another along the furnace section. In other words, they are different distances away from the longitudinal ends of the furnace section. This achieves an improved equal distribution of temperature due to a flow which reaches all the blanks.

A loading device and an unloading device are preferably arranged at both ends of the furnace section. These devices preferably each have a transfer stage, which can transfer a plurality of furnace bogies laterally in relation to the furnace section. Then the fired blanks can be transferred with a lateral offset by the furnace bogies or otherwise unloaded, and blanks to be fired can be loaded.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

Additional advantages and details of the invention can be derived from the following description of the figures.

The figures show schematically:

FIG. 1 a schematic top view of part of a furnace according to the invention,

FIG. 2 a cross section through another object according to the invention,

FIG. 3 a partial view of a section III-III through the object according to the invention as shown in FIG. 2,

FIG. 4 a loading situation,

FIG. 5 an unloading situation,

FIG. 6 a firing curve, which is varied over the variation in the cross-circulation rate in the circulation zones.

Parts which act in the same or similar ways are provided with identical reference numerals—if appropriate. Individual technical features of the exemplary embodiments, which are described below, can also lead to further embodiments of the invention having the features of the exemplary embodiments described above.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

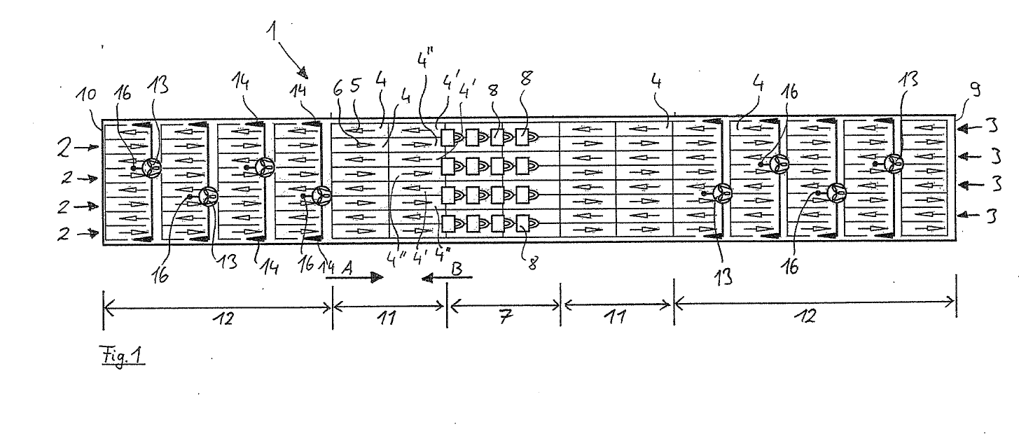

FIG. 1 shows a schematic and partially perspective top view of an object according to the invention. This shows a furnace section, which is labeled in general as numeral 1, and on which a total of eight furnace trains are arranged. In the plane of the figure, furnace trains labeled with the numeral 2 travel in the direction A, i.e., to the right, while furnace trains labeled with the numeral 3 travel in the direction B, i.e., to the left. Each furnace train 2, 3 has a plurality of furnace bogies and/or hearth furnace bogies 4, which are arranged in a row in the longitudinal direction (A and/or B), identified partially by arrows 5 and/or 6. The furnace bogies 4 of the furnace trains 2 are loaded at the left end in the figure and are unloaded at the right end, while the bogies with the furnace trains labeled with numeral 3 are loaded at the right end accordingly and are unloaded at the left end.

The furnace has a central firing zone 7, in which a plurality of firing elements 8 is arranged. The lateral ends 9 and 10 of the furnace section are connected on both ends to radiant heat zones 11 which are in turn each adjacent to a circulation zone 12.

Whereas all the blanks are heated in the firing zone 7, the circulation zones as well as the radiant heat zones serve on the one hand to heat the blanks that have not yet been fired and on the other hand at the same time they cool the blanks that have already left the firing zone. A transition of blanks into the firing zone and/or out of the firing zone takes place by a movement of the trains arranged side by side in opposite directions. Blanks that are situated on furnace bogies 4′ and have left the firing zone 7 during one cycle of the furnace train are positioned next to the blanks already on the furnace bogies 4″ and heat is transferred from the blanks already fired to those that have not yet been fired.

After the blanks that have already been fired are cooled down to 700° C.-800° C. in the radiant heat zone, they enter one of the circulation zones 12 after repeated transfer of the trains. In each of the two circulation zones 12 there are fans 13 mounted on the ceiling with inflow openings above the blanks, creating a cross-circulation of the gases in the furnace tunnel. Arrows 14, which are to be considered perspectively, indicate that air conveyed by the fans 13 is transported laterally to the longitudinal ends of the furnace section and is conveyed there further laterally and downward to the height of the blank. The arrangement of fans is shown in a slightly perspective arrangement where small circles 16 which have been filled in indicate the position of a fan with respect to the plane of the blanks. The blanks are loaded at both ends of the furnace section and are moved through the firing zone in both directions without any reversal of direction and without any transfer offset and then are unloaded from the furnace section at the opposite end with respect to their loading point.

The firing elements 8, which are diagrammed schematically, are arranged between the trains in the longitudinal channels, which are not shown in greater detail, but they may also be arranged above the blanks. Due to the transfer of heat from the fired blanks to the unfired blanks and/or bricks, the bricks that have already been fired do not require extra cooling. There is no separate supply of cooling air. Nevertheless it may be appropriate to increase the oxygen content of the flue gas/air mixture to 10% to 15% by supplying a small amount of oxygen to the extent stipulated above.

With conventional tunnel furnaces, the ratio of cross-circulated mass to longitudinally circulate mass for unit of time is ≦1 but with the furnaces according to the invention, the ratio of the cross-circulated air/flue gas mixture to the air conveyed along the furnace section in the direction A or B is >50. For cross-circulation, for example, the air drawn in by one of the fans 13 and conveyed across the longitudinal extent of the furnace section is considered.

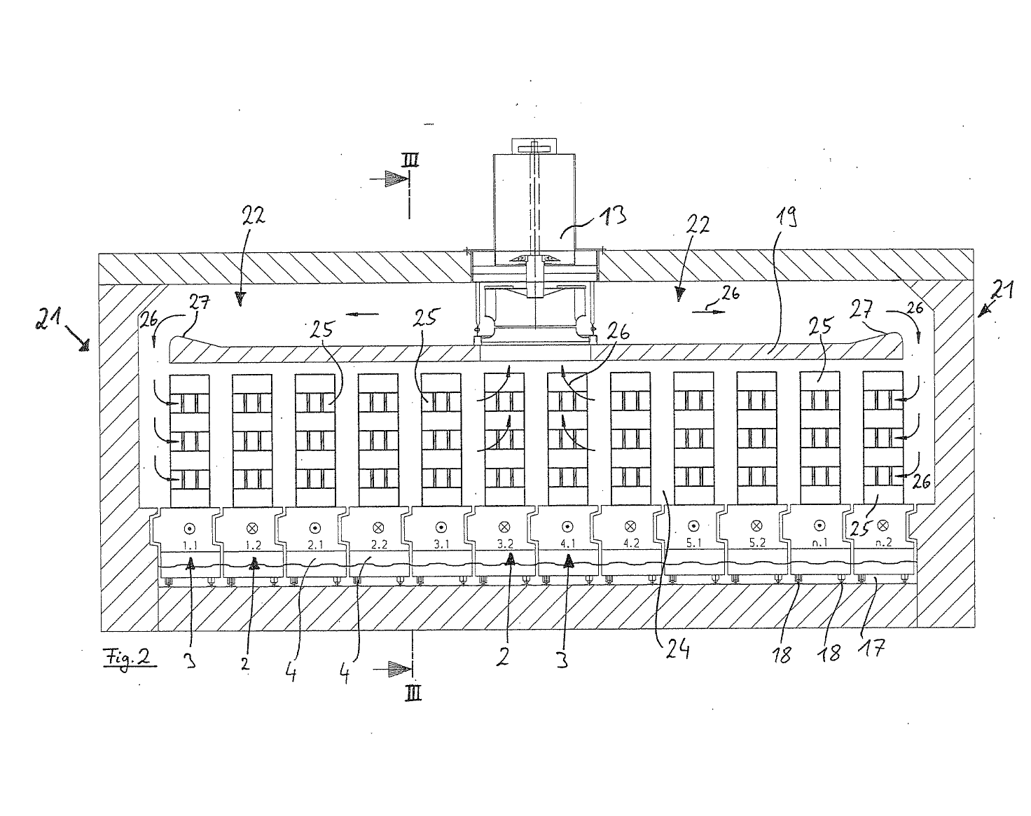

FIG. 2 shows a cross section through a circulation zone of another object according to the invention. In the exemplary embodiment presented here, twelve furnace trains 2, 3 are arranged side by side, where numerals 1.1, 1.2, 2.1, 2.2 to n.2 denote the numbering of pairs of rails 18. All the furnace trains 2, 3 run in a water bath 17, which is known per se, and run on rails 18, which are also known per se. The furnace bogies 4 have corresponding side areas to reduce the heat input into the water bath.

In the circulation zone, there is a wall 19, which is embodied as a ceiling through which circulation channels 22 run toward the ends 21. Due to a fan 13 embodied as a radial fan, the flue gas/air mixture in the main tunnel 24 is conveyed in the direction of the arrows 26. The ascending and rounded shape of the intermediate ceiling at the edges 27 improves the air flow in the circulation channel while preventing breakaway edges which lead to the formation of air turbulence. A type of ventilation grid is formed by the approximate grid-shaped stock structure of the blanks 25 arranged on the outermost right and left edges of the main tunnel 24, so that the circulated air can flow uniformly through the blanks. Firing elements may be arranged as far as the bottom blank in the firing zone so they are arranged in the longitudinal channels between the blanks of individual bogies/trains running in opposite directions from one another.

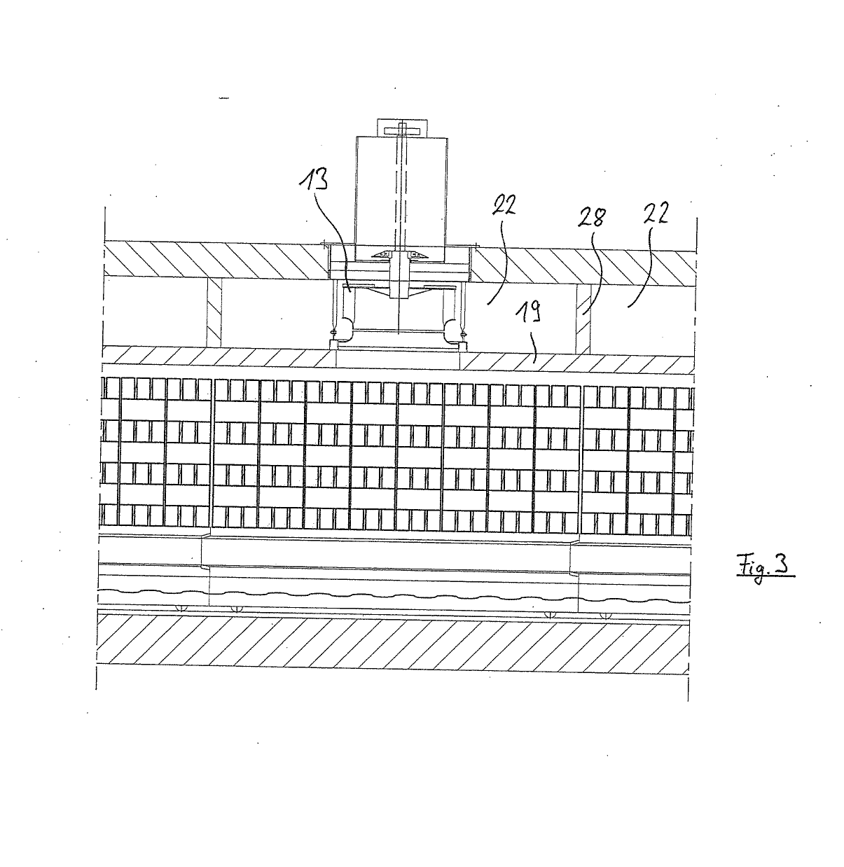

FIG. 3 shows the cross section according to FIG. 2. This is shown in a view that is cutaway at the right and left. It can be seen that neighboring circulation channels 22 are separated from one another by side walls 28. In the present exemplary embodiment, a fan is provided for each circulating channel 22, which is the length of one furnace bogie when considered in the longitudinal direction.

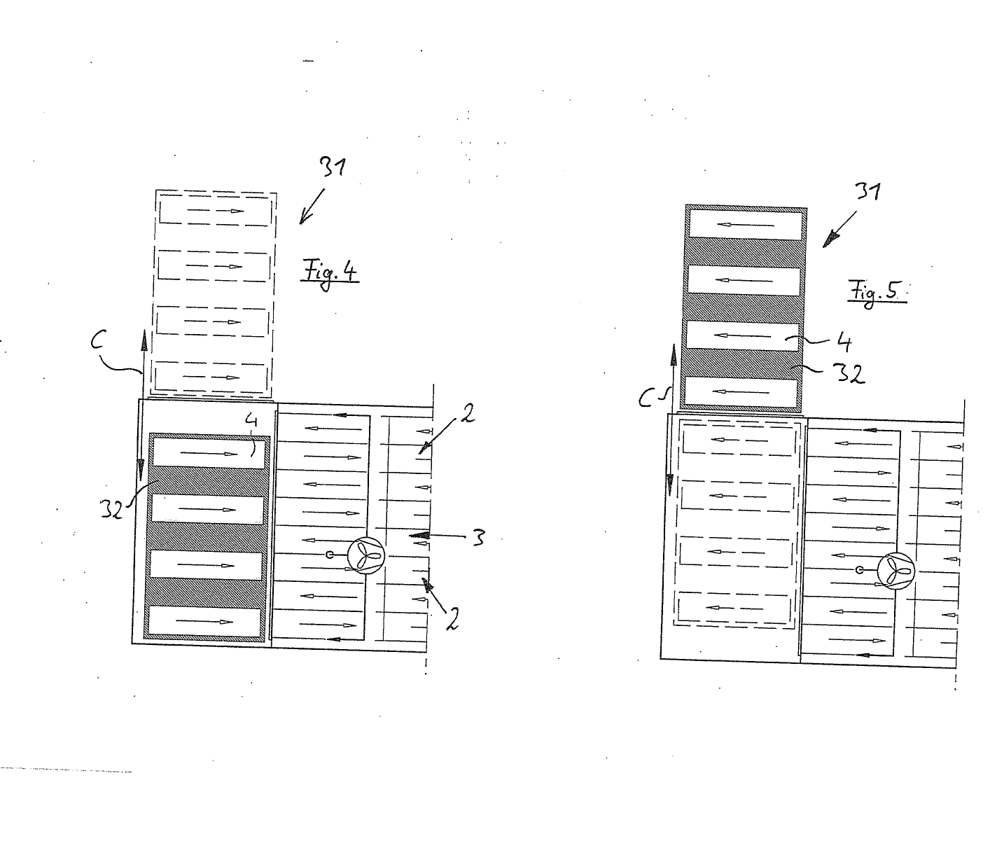

FIG. 4 shows the left end of the furnace section according to FIG. 1 in a loading situation and with a loading and unloading device 31. The loading and unloading of the furnace section are performed by transfer stage 32 which has eight tracks and can move crosswise in direction C. In the situation indicated with dotted lines, the furnace bogies are loaded with unfired blanks. Next the transfer stage shifts the corresponding tracks (1.2, 2.2, 3.2, n.2) in direction C and the furnace bogies can be integrated into the trains 2.

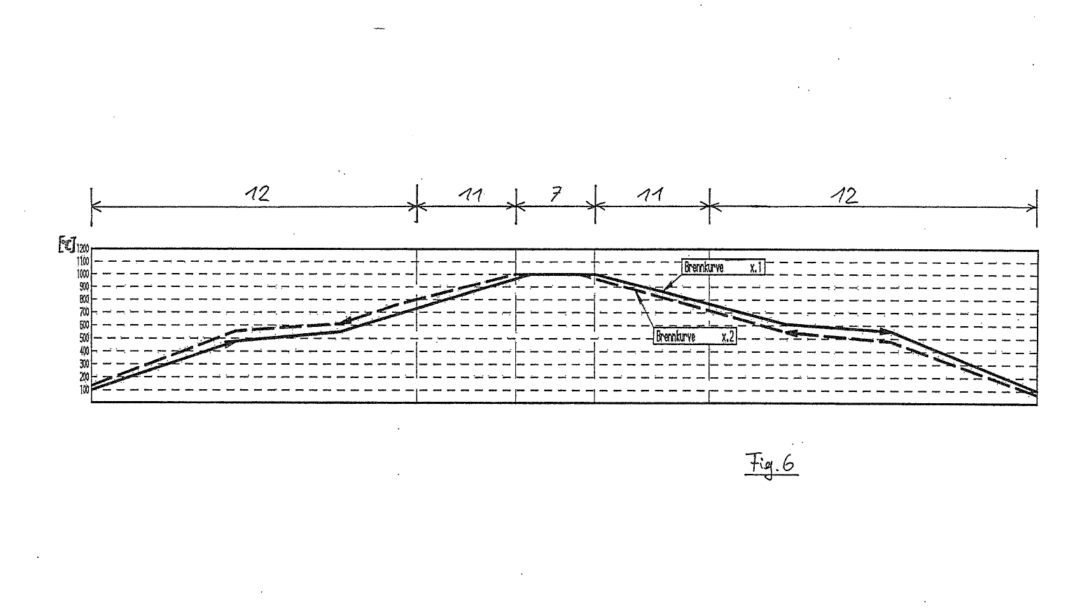

Next the transfer stage can be moved, having been offset by one track, into the position indicated with dotted lines in FIG. 5 to receive furnace bogies loaded with blanks that have already been fired. Next the transfer stage again moves into the position shown continuously in FIG. 5, said position being next to the furnace section. In this position, the finished blanks are unloaded, whereupon dry blanks can again be placed on the bogies. The entrance into the furnace section may typically be provided with an airlock.

FIG. 6 shows the shape of two firing curves x.1 and x.2 as a function of the temperature (in ° C.) along the furnace section. This shows a solid line for a first track, while the firing curve for a neighboring second track is shown with dotted lines. Arrows drawn in the respective curves indicate the direction of movement of the blanks along the track. The line shown with a dotted line indicates blanks, which are moved from right to left in the plane of the figure.

The two curves have identical temperatures for the blanks in the firing zone 7, while the temperatures dropped uniformly in the radiant heat zones 11. The curves show a plateau on both ends of the radiant heat zones 11 due to the suitably adjusted fans for cross-circulation of the air in the circulation zones 12, by means of which conversion processes of organic material in the blanks can be controlled in an improved manner, for example. Unloading of the blanks on both ends of the furnace section is performed at temperatures usually below 120° C.

The combustion chamber of a furnace according to the invention may also be operated as an external combustion chamber using energy sources of all types, for example, using pellets or combustible refuse, which can further improve the energy balance of the furnace.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

1. A method for firing ceramic blanks in a furnace and guiding a plurality of blanks arranged in trains running parallel to one another along a longitudinal furnace section with a firing zone in which the blanks are heated, wherein trains arranged side by side move in opposite directions and the furnace is loaded with blanks to be moved in a first direction on one end of the furnace section, wherein said blanks to be moved in a second, opposite direction are loaded at the first end and then at the second end of the furnace section opposite the firing zone, the blanks are moved through the firing zone without a reversal of direction and are each unloaded from the furnace section at the opposite end from where they were loaded.

2. The method according to claim 1, wherein the blanks are heated in the firing zone by at least one heating element arranged in a longitudinal channel between the trains.

3. The method according to claim 1, wherein the blanks are heated in the firing zone by at least one heating element arranged directly above a longitudinal channel between the trains.

4. The method according to claim 1, wherein the blanks which are still upstream from the firing zone in a train are heated by radiant heat from the blanks already leaving the firing zone in the neighboring furnace train moving in the opposite direction, this being accomplished in adjacent radiant heat zones connected and extending along the furnace section on both ends of the firing zone, in particular comprising multiple furnace bogies.

5. The method according to claim 4, wherein the heating is performed without cooling air passing along the furnace section and through the firing zone.

6. The method according to claim 1, wherein air is circulated across the longitudinal extent of the furnace section in circulation zones on both ends of the firing zone.

7. The method according to claim 6, wherein the air is drawn in by a fan situated above or at the side of the trains for cross-circulation and is directed in particular above an intermediate ceiling in the furnace in the crosswise direction in order to flow inward through the blanks and to be directed downward at the end of the outer furnace trains, as seen in the longitudinal direction of the furnace section.

8. The method according to claim 6, wherein the ratio of the gas mass flow circulating across the gas mass flow that is directed longitudinally to the furnace section is greater than 10.

9. The method according to any one of claim 6, wherein there is a variation in the firing curve over the variation in the rate of air circulated crosswise.

10. The method according to claim 1, wherein oxygen is added to support the conversion of organic material in the blank in a temperature range of <700° C. along the furnace section.

11. A furnace for firing ceramic blanks having a plurality of trains comprising multiple furnace bogies movable in parallel with one another and along a longitudinal furnace section, the blanks being arranged on these trains, such that the furnace section has a firing zone for heating the blanks and such that trains arranged side by side are movable in opposite directions and the furnace is provided with blanks to be moved in a first direction on the first end of the furnace section for loading into the furnace, wherein the furnace is designed on the second end of the furnace section which is opposite the first end with respect to the furnace section for loading with the blanks to be moved into the opposite second direction, the blanks each being movable through the firing zone without a reversal in direction and each being removable at the opposite end of the furnace section with respect to their loading point.

12. The furnace according to claim 11, further comprising two radiant heat zones between the opposite ends of the furnace section with respect to the firing zone.

13. The furnace according to claim 11, further comprising two circulation zones arranged between the opposite ends of the furnace section with respect to the firing zone.

14. The furnace according to claim 13, further comprising at least one fan provided in the circulation zones for cross-circulation of gas present there.

15. The furnace according to claim 13, wherein at least one of the circulation zones has at least one separate wall by which at least one circulation channel is separated from a main tunnel of the furnace section.

16. The furnace according to claim 15, further comprising a plurality of circulation channels running across the longitudinal direction of the furnace section, such channels being structurally separated from one another.

17. The furnace according to claim 13, further comprising a plurality of fans, wherein said fans are arranged so they are offset from one another along the furnace section.

18. The furnace according to claim 11, further comprising a loading and unloading device arranged on each of the two ends of the furnace section, each preferably being able to transfer a plurality of furnace bogies laterally to the furnace section by means of a shifting platform.
